(19) United States
(12) Patent Application Publication
(10) Pub. No.: US 2023/0057491 A1
(43) Pub. Date: Feb. 23, 2023

(54) STEERING SHAFT ASSEMBLY FOR A MOTOR VEHICLE

(71) Applicant: THK Rhythm Automotive GmbH, Duesseldorf (DE)

(72) Inventor: Ryan IRRER, Duesseldorf (DE)

(21) Appl. No.: 17/759,318

(22) PCT Filed: Jan. 21, 2021
(86) PCT No.: PCT/EP2021/051369

§ 371 Date: Jul. 22, 2022

(30) Foreign Application Priority Data
Jan. 24, 2020 (EP) 20153661.2

(51) Int. Cl. B62D 1/185; F16C 3/035; F16D 3/06

(52) U.S. Cl. CPC B62D 1/185; F16C 3/035; F16D 3/065; F16C 2226/80; F16C 2326/24

(57) ABSTRACT

A steering shaft assembly (10) for a motor vehicle is described, comprising a first shaft (20) and a second shaft (22), both of which are rotatable about a central axis (24). The second shaft (22) is a hollow shaft and a portion of the first shaft (20) is received so as to be axially displaceable inside the second shaft (22). The first shaft (20) and the second shaft (22) are also coupled in a torque-transmitting manner via two rotary coupling mechanisms (26, 28) separate from each other.

The invention relates to a steering shaft assembly for a motor vehicle, comprising a first shaft and a second shaft which are both rotatable about a central axis, the second shaft being a hollow shaft and a portion of the first shaft being received so as to be axially displaceable within the second shaft.

Such steering shaft assemblies are known from the prior art. They are used in particular for steering shaft assemblies the axial length of which is adjustable to be able to adapt a position of a steering wheel connected to the steering shaft assembly to a driver of the motor vehicle.

A simple adjustability of the steering shaft assembly is generally required, i.e. a displacement of the first shaft in relation to the second shaft should be possible without high effort. At the same time, it must be ensured that the steering shaft assembly can still transmit a certain torque even in the event of a defect in the area of the coupling of the first shaft with the second shaft, so that the motor vehicle equipped with the steering shaft assembly remains steerable.

Against this background, the object of the invention is to specify an improved steering shaft assembly. It should ensure good steerability of the motor vehicle equipped therewith, especially in the event of a defect. In addition, the steering shaft assembly should have a simple and cost-effective structure.

The object is achieved by a steering shaft assembly of the type initially mentioned, in which the first shaft and the second shaft are coupled in a torque-transmitting manner via two rotary coupling mechanisms separate from each other. Each of the rotary coupling mechanisms is suitable for transmitting a torque required to steer the vehicle. The first shaft and the second shaft are thus coupled redundantly with regard to torque transmission. In the event that one of the rotary coupling mechanisms is defective, the vehicle thus remains steerable via the other rotary coupling mechanism. The steering shaft assembly is thus particularly robust against defects.

The two rotary coupling mechanisms may each have a different play in the direction of rotary coupling, so that in normal operation, the rotary coupling is substantially realized via the rotary coupling mechanism having the smaller play. The rotary coupling mechanism having the greater play is therefore only used when the rotary coupling mechanism having the smaller play has a defect. The greater play results in that the associated rotary coupling mechanism provides no or little resistance during axial displacement of the steering shaft assembly, i.e. when the first shaft is axially displaced relative to the second shaft. This allows the steering shaft assembly to be easily adjusted.

According to one embodiment, a first of the two rotary coupling mechanisms has at least one rolling body which is mounted in a form-fitting manner on both the first shaft and the second shaft in the rotary coupling direction, in particular wherein the rolling body acts as an axial guide element. The first shaft and the second shaft are thus rotationally coupled in a form-fitting manner via the at least one rolling body. This results in reliable torque transmission. Furthermore, an axial adjustment, i.e. an axial displacement of the first shaft with respect to the second shaft, takes place via the at least one rolling body. This allows the first shaft to be displaced relative to the second shaft with comparatively little effort. Preferably, the first of the two rotary coupling mechanisms has less play in the rotary coupling direction than a second of the two rotary coupling mechanisms. The rolling body is in particular a ball. Thus, the first shaft is supported by ball bearings in the axial direction relative to the second shaft.

The rolling body may be received in an axial groove on an outer circumference of the first shaft and/or in an axial groove on an inner circumference of the second shaft. Axial grooves are comparatively easy to manufacture. Therefore, the steering shaft assembly as a whole is also easy to manufacture. This also ensures reliable coupling of the first shaft with the second shaft.

A plurality of axial grooves is preferably provided on the outer circumference of the first shaft. Each axial groove of the first shaft has an axial groove on the inner circumference of the second shaft arranged opposite thereto. At least one rolling body is received in each pair of opposite axial grooves. It is thus possible to ensure reliable torque transmission between the first shaft and the second shaft. Furthermore, such a rolling bearing arrangement allows the first shaft to be easily displaced relative to the second shaft.

In one variant, the at least one rolling body is guided in a rolling body cage. The rolling body is therefore always held in the position intended therefor. As a result, the steering shaft assembly operates in a reliable and accurate manner.

Furthermore, a second of the two rotary coupling mechanisms may have a rotary coupling part which is attached to the first shaft and is mounted in a form-fitting manner on the second shaft in the rotary coupling direction. In particular, the rotary coupling part is mounted on the second shaft so as to be axially displaceable. Preferably, the second of the two rotary coupling mechanisms has a greater play in the rotary coupling direction than the first of the two rotary coupling mechanisms. Thus, the second rotary coupling mechanism is only effective if a defect occurs in the first rotary coupling mechanism. In the event that the first rotary coupling mechanism has rolling bodies, such a defect may consist in the loss of one or more rolling bodies. The first shaft and the second shaft are then still reliably coupled in a torque-transmitting manner via the second rotary coupling mechanism.

Preferably, the rotary coupling part has at least one coupling projection on the outer circumference thereof, which engages in an axial groove on an inner circumference of the second shaft. Such a coupling is easy to establish and reliable in operation. The axial groove on the inner circumference of the second shaft is preferably the same as that used for receiving the rolling bodies of the first rotary coupling mechanism. Altogether, a simple structure of the steering shaft assembly is achieved.

The rotary coupling part may also have a plurality of coupling projections arranged so as to be distributed on the outer circumference thereof, each coupling projection engaging in an associated axial groove on the inner circumference of the second shaft. This results in a particularly reliable coupling of the first shaft with the second shaft. Two to six coupling projections may be provided. In particular, the rotary coupling part has three coupling projections.

Preferably, the rotary coupling part is connected to the first shaft in a force-fitting manner, in particular with an end portion of the first shaft. Preferably, the rotary coupling part is pressed onto the first shaft. The rotary coupling part is thus reliably connected to the first shaft. Furthermore, the rotary coupling part can be easily mounted on the first shaft.

The rotary coupling part can be connected to a toothed end portion of the first shaft via a press-fit connection. In particular, the toothing at the end portion of the first shaft is deformed when the rotary coupling part is pressed thereon. Alternatively or additionally, the rotary coupling part may also be deformed, in particular the inner circumference thereof. This results in a reliable connection of the rotary coupling part to the first shaft. Furthermore, the manufacture of such a connection is simple and cost-effective.

The invention will be explained below with reference to an example embodiment shown in the accompanying drawings, in which:

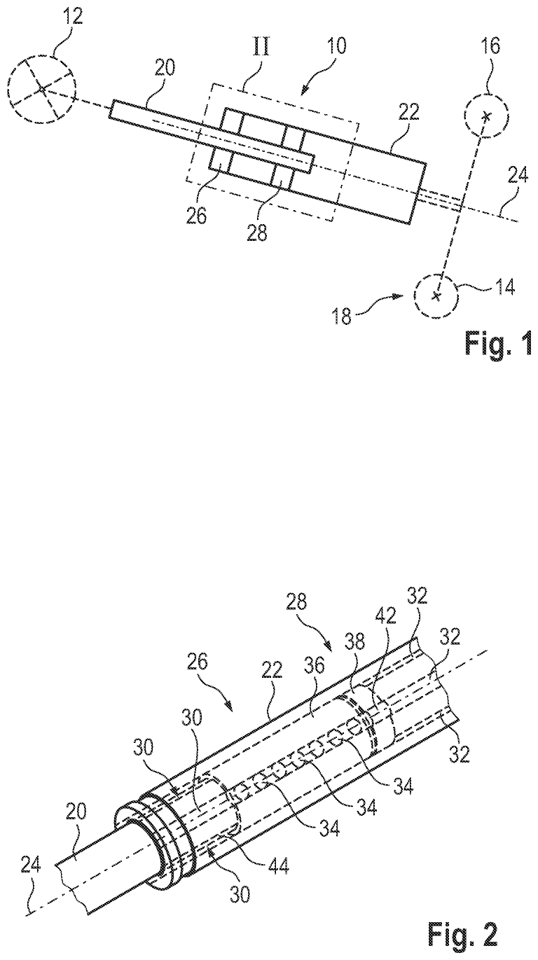

FIG. 1 shows a steering shaft assembly according to the invention in a schematic representation,

FIG. 2 shows a detail II of FIG. 1 in a perspective detail view,

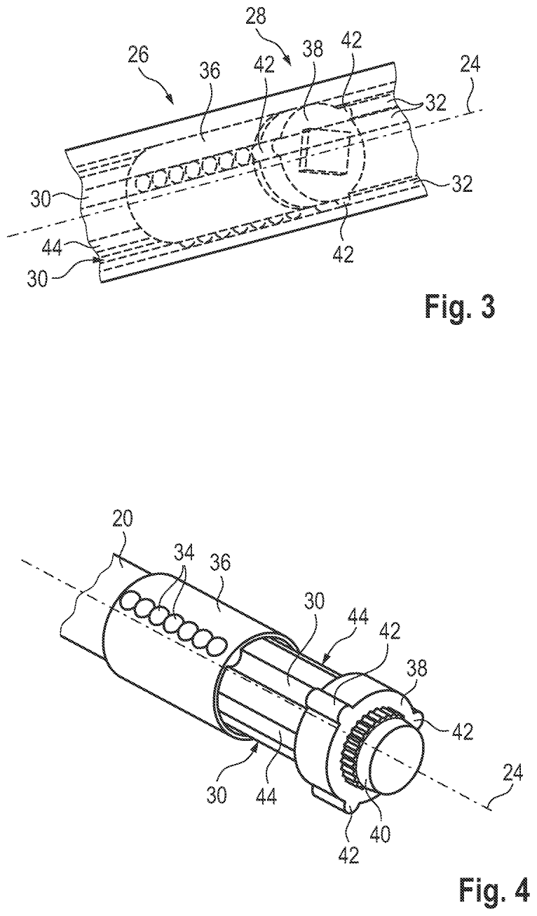

FIG. 3 shows the detail II of FIG. 1 from a different perspective than FIG. 2, and

FIG. 4 shows the steering shaft assembly according to the invention in a perspective view, with the second shaft omitted.

FIG. 1 shows a steering shaft assembly 10.

For better understanding, a coupling of the steering shaft assembly 10 to a steering wheel 12 and wheels 14, 16 of a steerable motor vehicle axle 18 is indicated by dashed lines.

The steering shaft assembly 10 comprises a first shaft 20 which is coupled to the steering wheel 12 in the illustrated example embodiment, and a second shaft 22 which is connected to the steerable motor vehicle axle 18 in the illustrated example embodiment.

Both shafts 20, 22 are rotatable about a central axis 24.

The second shaft 22 is configured as a hollow shaft. A portion of the first shaft 20 is received inside the second shaft 22 so as to be axially displaceable.

The first shaft 20 and the second shaft 22 are coupled in a torque-transmitting manner via a first rotary coupling mechanism 26 and a second rotary coupling mechanism 28. The two rotary coupling mechanisms 26 and 28 are separate from each other.

A plurality of axial grooves 30 is provided on the outer circumference of the first shaft 20.

An axial groove 32 on the inner circumference of the second shaft 22 is arranged opposite each of these axial grooves 30.

In each pair of axial grooves 30, 32, rolling bodies 34 are received which are thus mounted in a form-fitting manner in the rotary coupling direction on both the first shaft 20 and the second shaft 22.

Consequently, the first shaft 20 and the second shaft 22 are coupled in a form-fitting manner in the rotary coupling direction via the rolling bodies 34.

In the example embodiment shown, eight rolling bodies 34 are provided in each pair of axial grooves 30, 32, of which only some are provided with a reference numeral for reasons of clarity.

In the example embodiment shown, the rolling bodies 34 are balls.

The rolling bodies 34 are guided in a rolling body cage 36 to protect them against loss and to position them in groups on the shafts 20, 22.

The coupling of the first shaft 20 and the second shaft 22 via the axial grooves 30, 32 and the rolling bodies 34 arranged therein constitutes the first rotary coupling mechanism 26.

The second rotary coupling mechanism 28 includes a rotary coupling part 38 which is connected to a toothed end portion 40 of the first shaft 20 by means of a press-fit connection.

The rotary coupling part 38 is thus coupled to the first shaft 20 in a force-fitting manner.

In the embodiment shown, the rotary coupling part 38 has a total of three coupling projections 42, which are arranged evenly distributed around the outer circumference thereof.

Each of the coupling projections 42 engages in one of the axial grooves 32 on the inner circumference of the second shaft 22.

The second rotary coupling mechanism 28 is thus formed by the rotary coupling part 38 with the coupling projections 42, the press-fit connection thereof onto the first shaft 20 and the associated axial grooves 32.

The coupling projections 42 can be displaced along the central axis 24 relative to the second shaft 22, but are coupled thereto in a form-fitting manner in the rotary coupling direction.

The coupling projections 42 are configured so as to have a play in the rotary coupling direction relative to the respectively associated axial grooves 32 which is greater than the play of the first rotary coupling mechanism 26 oriented in the rotary coupling direction.

As a result, the rolling bodies 34 constitute axial guide elements when the first shaft 20 is displaced relative to the second shaft 22 along the central axis 24.

Due to the greater play, the coupling projections 42 do not contact the walls and the base of the axial grooves 32 during axial displacement or only contact them to a small extent.

The second rotary coupling mechanism 28 does not take part in the rotary coupling, either, due to the greater play. This situation is referred to as normal operation.

Only when a defect occurs in the first rotary coupling mechanism 26, i.e. when the steering shaft assembly 10 is operating in a fault mode, the coupling projections 42 contact the walls and/or the base of the axial grooves 32, thus ensuring that torque can still be transmitted from the steering wheel 12 to the vehicle axle 18.

For example, a defect results in the loss of the rolling bodies 34.

Finally, it should be noted that the first shaft 20 has additional axial grooves 44. However, they only serve to reduce weight and not to provide a rotary coupling of the shafts 20, 22.

1. A steering shaft assembly for a motor vehicle, comprising:
a first shaft and a second shaft, both of which are rotatable about a central axis, wherein the second shaft is a hollow shaft and a portion of the first shaft is received so as to be axially displaceable inside the second shaft, wherein the first shaft and the second shaft are coupled in a torque-transmitting manner via two rotary coupling mechanisms separate from each other.

2. The steering shaft assembly according to claim 1, wherein the two rotary coupling mechanisms each have a different play in a rotary coupling direction so that in normal operation, the rotary coupling takes place substantially via the rotary coupling mechanism having the smaller play.

3. The steering shaft assembly according to claim 1, wherein a first of the two rotary coupling mechanisms has at least one rolling body which is mounted in a form-fitting manner both on the first shaft and on the second shaft in the rotary coupling direction, in particular wherein the rolling body acts as an axial guide element.

4. The steering shaft assembly according to claim 3, wherein the rolling body is received in an axial groove on an outer circumference of the first shaft and/or in an axial groove on an inner circumference of the second shaft.

5. The steering shaft assembly according to claim 4, wherein a plurality of axial grooves is provided on the outer circumference of the first shaft, and in that each axial groove of the first shaft has an axial groove on the inner circumference of the second shaft arranged opposite thereto, wherein at least one rolling body is received in each pair of axial grooves which are opposite each other.

6. The steering shaft assembly according to claim 3, wherein the at least one rolling body is guided in a rolling body cage.

7. The steering shaft assembly according to claim 1, wherein a second of the two rotary coupling mechanisms has a rotary coupling part which is fastened to the first shaft and is mounted in a form-fitting manner on the second shaft in the rotary coupling direction, in particular wherein the rotary coupling part is mounted so as to be axially displaceable on the second shaft.

8. The steering shaft assembly according to claim 7, wherein the rotary coupling part has at least one coupling projection on its outer circumference which engages in an axial groove on an inner circumference of the second shaft.

9. The steering shaft assembly according to claim 8, wherein the rotary coupling part has a plurality of coupling projections arranged so as to be distributed on the outer circumference thereof, wherein each coupling projection engages in an associated axial groove on an inner circumference of the second shaft.

10. The steering shaft assembly according to claim 7, wherein the rotary coupling part is connected to an end portion of the first shaft in a force-fitting manner.

11. The steering shaft assembly according to claim 10, wherein the rotary coupling part is connected to a toothed end portion of the first shaft via a press-fit connection.
